(19) United States
(12) Patent Application Publication
(10) Pub. No.: US 2002/0083671 A1
(43) Pub. Date: Jul. 4, 2002

(54) Mould resistant decorative panel

(76) Inventors: Arne Clausen, Toronto (CA); Bryce Clark, Bolton (CA)

Correspondence Address: Elias C Borges,, 10 KINGSBRIDGE GARDEN CIRCLE, SUITE 704, CANADA, ON, L5R3K6, CA

(21) Appl. No.: 09/732,652

(22) Filed: Dec. 5, 2000

(51) Int. Cl. E04B 1/72; A01N 25/34

(52) U.S. Cl. 52/517; 52/796.1; 424/413; 428/907

(57) ABSTRACT

An improved mould resistant gypsum wall board for use in constructing walls is disclosed. The wall board comprises a water resistant gypsum core having opposite first and second surfaces, the first and second surfaces of the gypsum core being covered by a non-biodegradable structural mat, a plastic sheet bonded to the structural mat cover of the first surface by a bonding agent, the bonding agent being made of a non-biodegradable adhesive. The structural mat is preferably made of fiberglass and the bonding agent preferably consists of an aqueous solution of a plasticizer, ethylene vinyl acetate and an acetate copolymer. The plastic sheet is preferably made of vinyl and contains an anti-biotic chemical agent selected to inhibit the growth of mould.

### FIELD OF THE INVENTION

The invention relates generally to decorative gypsum wall panels of the type used to construct walls.

### BACKGROUND OF THE INVENTION

Gypsum wall boards used for constructing interior walls are well known. Traditional gypsum wall panel constructions generally comprised a plurality of gypsum cored wall panels (dry wall panels) mounted to a wooden or metal wall frames. These wall panels were mounted to the frames in abutting end-to-end alignment and secured to the wall panels via nails or screws. The joint formed between two abutting wall panels was generally filled with a drywall compound and then finished to provide a smooth, flat surface. A decorative surface could then be applied to the inside surface of the wall panels by applying paint, stucco, or wallpaper.

While traditional gypsum wall panel constructions continue to be widely used in residential construction, the costs associated with this type of construction has limited its use in commercial applications. In commercial applications, partition walls are often re-arranged to suit the needs of the consumer. The labour intensive nature of traditional gypsum wall construction techniques makes re-configuring partition walls prohibitive. In response, modified wall panels have been developed which can be attached to a wall frame construction by means of clips or other attachment fasteners. These wall panels have relatively square side edges, so that when two panels are joined together in abutting relationship, the joint formed by the two abutting wall panels is relatively unobtrusive. To speed construction, these panels may have a decorative wallpaper surface pre-applied to one surface of the panel, thereby eliminating one step in the process of forming an internal partition wall.

While traditional and modular gypsum core wall panel construction remains very popular in both residential and commercial construction, these wall panel construction systems can, under certain circumstances, be prone to mould contamination. Essentially, moulds and other fungi can grow and spread within a wall construction, particularly if the relative humidity is high. Mould contamination can not only lead to a deterioration of the aesthetic appeal of the wall panels, it can actually pose a health risk to individuals. This is particularly a concern in schools where mould contamination can result in illness to both teachers and students. Once a wall construction has been contaminated by mould, the only truly effective means of eliminating the problem, is to remove the infected wall components. To minimize mould growth, water resistant coatings can be applied to gypsum wall panels in order to limit the buildup of moisture in the panels, and therefore retard the rate of mould growth. However, simply coating the wall panels with water resistant materials may not prevent mould contamination, since moisture can accumulate in these wall panels over extended periods of time, either through peculation or through defects in the coating. There remains a need for a wall panel which is resistant to mould growth.

### SUMMARY OF THE INVENTION

In accordance with the present invention, there is provided an improved mould resistant gypsum wall board for use in constructing walls, said wall board comprising a water resistant gypsum core having opposite first and second surfaces, the first and second surfaces of the gypsum core being covered by a non-biodegradable structural mat, a plastic sheet bonded to the structural mat cover of the first surface by a bonding agent, the bonding agent being made of a non-biodegradable adhesive.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### BRIEF DESCRIPTION OF THE DRAWINGS

FIG. 1 is a cross-sectional view of a wall panel made in accordance to the present invention;

FIG. 2 is a perspective view partly in section of a wall panel made in accordance with the present invention.

In the drawings like characters of reference indicate corresponding parts in the different figures.

### DETAILED DESCRIPTION OF THE PREFERRED EMBODIMENT

Traditional gypsum wall panels are prone to mould contamination. When exposed to prolonged periods of relatively high humidity, mould and fungus will grow on ordinary gypsum wall panels. In particular, the mould will establish itself in the paper backing material used in the wall panel construction. It has been discovered that certain species of mould can actual use the cellulose and other organic components of the paper backing material as a food source. Where the wall panel also has a decorative wallpaper treated surface, the mould will actually establish itself in the wallpaper itself. In addition, the adhesives used to adhere the paper backing to the gypsum core, and the adhesives used to adhere the wallpaper to the wall board may contain organic compounds which the mould may use as a food source. Therefore, merely treating the wall panel with a water resistant or waterproof coating is not sufficient. Over a period of years, moisture and humidity can make it's way through imperfections in any coatings. It is also believed that if even a portion of the panel core is exposed to water, the moisture will spread within the panel via percolation. Moulds can then establish themselves in the relatively moist wall panel and feed on the cellulose and other organic components used in the formation of the wall panel.

A wall panel may be made mould resistant if the wall panel does not have a medium upon which the mould can grow. In particular, the wall panel should not have any paper, cellulose, or other biodegradable material which can provide the mould with a food source. Additionally, antibiotic agents can be incorporated into the wall panel construction to ensure that any biodegradable contaminants which may make their way into the wall panel, either during the construction process or over a period of time as the product is used, will not foster the growth of mould. Finally, to minimize the amount of moisture in the wall panel, and therefore minimize the amount of mould growth, the wall panel core should be as water resistant as possible. If the panel core is itself water resistant, then even if moisture should make contact with a portion of the wall panel core, the water resistant characteristics of the wall panel core will prevent the moisture from spreading.

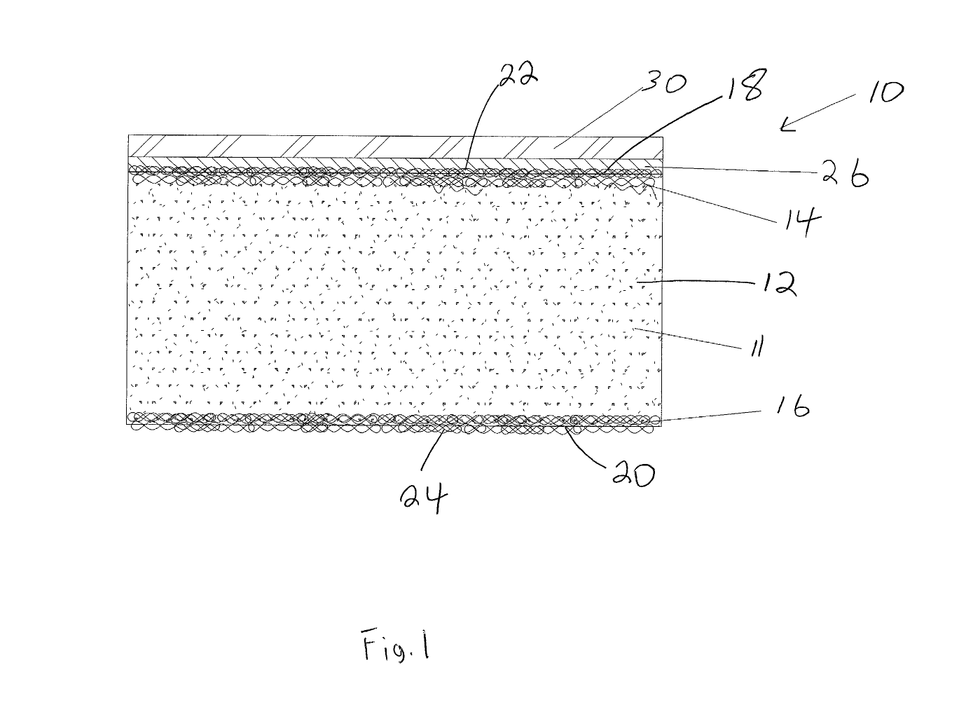

Referring firstly to FIG. 1, a wall panel made in accordance with the present invention is shown generally as item 10 and consists of a gypsum panel 11 having a core 12, opposite sides 14 and 16, opposite surfaces 18 and 20, and decorative vinyl layer 30 adhered to surface 18. Surfaces 18 and 20 are covered by non-biodegradable glass fibre matts 22 and 24. Vinyl layer 30 is adhered to surface 18 by adhesive layer 26, which consists of a layer of non-biodegradable adhesive.

Preferably panel 11 consists of a non-combustible, water resistant gypsum core panel which is glass mat faced. Sides 14 and 16 of wall panel 11 are impregnated with numerous glass fibres 22 and 24, which extend into the interior of panel 11 and which cover surfaces 18 and 20, respectively. Surfaces 18 and 20 are preferably free of gypsum and covered by fibrous mats 22 and 24, respectively. Fibrous mats 22 and 24 provide structural strength to wall panel 11. While any gypsum wall board which consists of a gypsum core bonded between non-biodegradable structural matts may be used, the glass backed wall panel disclosed in U.S. Pat. No. 4,647,496 has been found to be particularly useful.

Vinyl sheeting 30 is adhered to surface 18 via resin layer 26. Sheet 30 is preferably made of a non-biodegradable water resistant material such as vinyl and, when bonded to panel 12, forms a water resistant surface. Preferably, the adhesive comprising adhesive layer 26 consists of a non-biodegradable resin capable of adhering glass fibres to vinyl. It has been discovered that water based adhesives consisting of plasticizers, ethylene vinyl and acetate copolymers serve particularly well to bond decorative vinyl to glass backed gypsum wall panels.

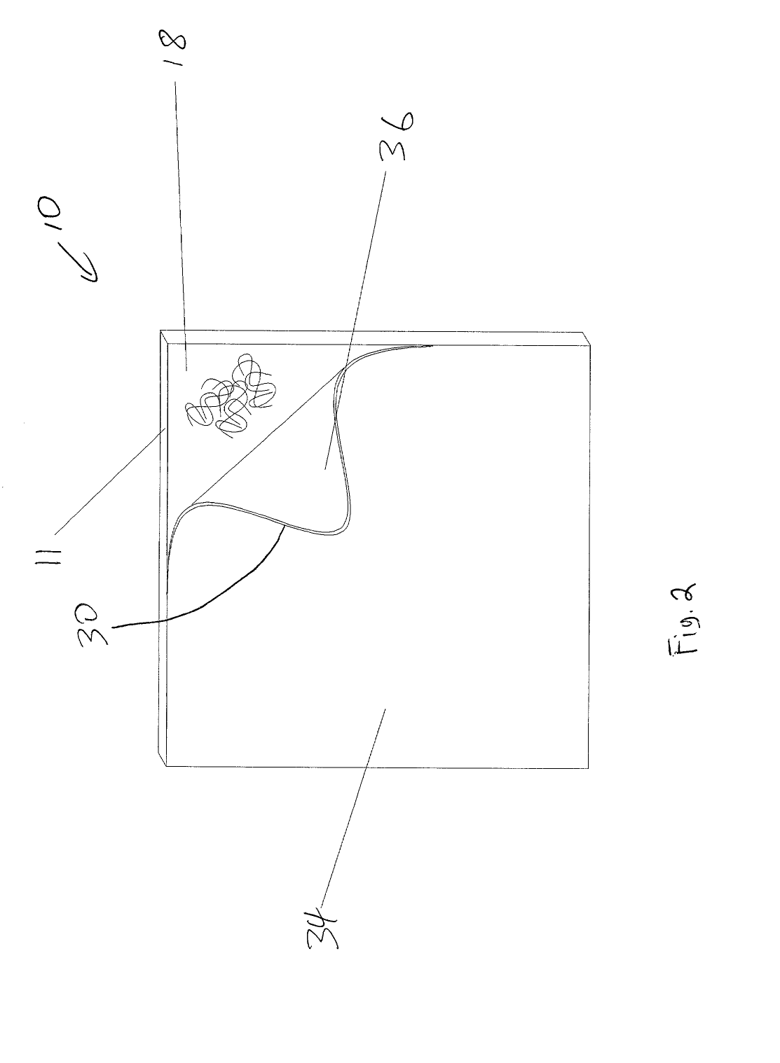

Referring now to FIG. 2, panel 10 may have only one decorative surface. For example, decorative vinyl sheet 30 can be attached to surface 18 of gypsum panel 11 by means of an appropriate adhesive. Sheet 30 will have a decorative surface 34 upon which is printed a decorative pattern and an opposite surface 36 which is adapted to adhere to the adhesive used to bond sheet 32 to gypsum panel 11. To minimize the likelihood of mould or other biological contamination of panel 10, sheet 30 may be impregnated with an anti-biological agent. Appropriate vinyl sheeting is readily available in the marketplace.

A method of constructing the wall panels will now be discussed. Essentially, the method consists of applying a layer of resin to one side of the vinyl sheet, and then applying the resin coated sheet to the surface of the gypsum wall panel. The vinyl sheet is then pressed against the gypsum wall panel to smooth out any wrinkles in the sheet and to ensure that adhesive layer is well bounded to the surface of the gypsum wall panel. The laminated wall panel is then held at room temperature to permit the adhesive to cure. The wall panel and vinyl sheet and both held at room temperature during the lamination process to reduce the risk of shrinkage during the curing period. The curing period will depend on the adhesive used, but for most water based ethylene vinyl adhesives, the curing period will be several minutes.

The lamination process is preferably carried out in a laminating machine. Vinyl laminating machines are readily available in the marketplace. These laminating machines usually apply the resin to one side of a continuous roll of vinyl and then press the coated vinyl to the wall panel via a series of rollers.

The mould resistance of the wall panels made in accordance with the present invention were tested. Three wall panel samples made in accordance with the present invention were tested in accordance with ASTM Specification G 26-1996. The following organisms were used in the test, namely Aspergillius Niger, Penicillium Pinophilum, Chaetomium Globosum, Gliocladium Virens and Aureobasidium Pullans. Method 508 for fungus and mould resistance was used. An incubation time of 28 days was used, and a 42x microscope was used to determine fungus growth. After 28 days of incubation, no fungus growth was observed.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

1. A mould resistant gypsum wall board for use in constructing walls, said wall board comprising;
a water resistant gypsum core having opposite first and second surfaces,
the first and second surfaces of the gypsum core being covered by a non-biodegradable structural mat,
a plastic sheet bonded to the structural mat cover of the first surface by a bonding agent,
the bonding agent being made of a non-biodegradable adhesive.

2. A mould resistant gypsum wall board as defined in claim 1 wherein the non-biodegradable mat is made of glass fibres.

3. A mould resistant gypsum wall board as defined in claim 2 wherein the adhesive is an aqueous solution of a plasticizer, ethylene vinyl acetate and an acetate copolymer.

4. A mould resistant gypsum wall board as defined in claim 1 wherein the plastic sheet has an anti-biotic chemical agent incorporated into the sheet, said anti-biotic agent adapted to inhibit the growth of mould.

5. A mould resistant gypsum wall board as defined in claim 4 wherein the plastic sheet is made of vinyl.
